(19) United States
(12) Patent Application Publication
(10) Pub. No.: US 2025/0232898 A1
(43) Pub. Date: Jul. 17, 2025

(54) TAPE WINDING METHOD AND WIRE HARNESS

(71) Applicant: Yazaki Corporation, Tokyo (JP)

(72) Inventors: Hiroyasu KOBAYASHI, Makinohara-shi (JP); Takahito Fujikawa, Susono-shi (JP); Jun Yagi, Makinohara-shi (JP); Kenji Katsumata, Susono-shi (JP)

(73) Assignee: Yazaki Corporation, Tokyo (JP)

(21) Appl. No.: 19/096,841

(22) Filed: Apr. 1, 2025

Related U.S. Application Data
(63) Continuation of application No. PCT/JP2024/007192, filed on Feb. 28, 2024.

(30) Foreign Application Priority Data
Mar. 30, 2023 (JP) 2023-055112

(51) Int. Cl. H01B 13/26; H01B 7/00; H01B 13/012

(52) U.S. Cl. CPC H01B 13/2613; H01B 7/0045; H01B 13/01209; H01B 13/01263

(57) ABSTRACT

The efficiency of the tape winding task is improved while a desired lapping width (R11) is secured. A tape winding method includes a winding start step (step S11 to step S14), a lapped winding step (step S15 and step S16) of performing lapped winding in which adjacent tapes (21) partially overlap each other, while the tape set (2) is moved by an amount of movement per lapped winding that is a sum of a tape spacing (T11) and a lapping width (R11), and a winding end step.

### TECHNICAL FIELD

This application is a continuation application of PCT International Application No. PCT/JP2024/007192, filed on Feb. 28, 2024, whose priority is claimed on Japanese Patent Application No. 2023-055112, filed on Mar. 30, 2023. All contents of both the PCT International Patent Application and the Japanese Patent Application are incorporated herein by reference.

The present invention relates to a tape winding method for winding tapes around a single electric wire or a bundle of multiple electric wires, and to a wire harness wound with tapes by such a tape winding method.

### BACKGROUND

Conventionally, a tape winding method for winding a single electric wire or a bundle of multiple electric wires with tapes for protection or the like is known (for example, see Patent Document 1). In such a tape winding method, product standards may require lapped winding, in which a tape is partially overlapped at required locations in the length direction. The tape winding method described in Patent Document 1 employs half-lapped winding, in which a tape is overlapped by ½ of the width.

### RELATED ART

### Patent Document

Patent Document 1: JP2001067955A

### SUMMARY OF THE INVENTION

### Problem to be Solved by the Invention

However, in the above-described lapped winding, in order to secure the desired lapping width, the amount of tape movement per winding is limited to the lapping width, making it difficult to improve the efficiency of the tape winding task.

Therefore, the present invention has been made in view of the above problems, and it is an object of the present invention to provide a tape winding method capable of improving the efficiency of the tape winding task while securing a desired lapping width, and also to provide a wire harness wound with tapes by such a tape winding method.

### Solution to Problem

In order to solve the above problems, a tape winding method includes a winding start step in which a single electric wire or a bundle of a plurality of electric wires is adopted as a tape winding target, and tape winding is performed on a winding start location of the tape winding target by a predetermined winding manner, a lapped winding step in which, subsequent to the winding start step, a tape set including a plurality of tapes arranged in a winding axis direction with a predetermined tape spacing is used to perform lapped winding in which adjacent tapes of the plurality of tapes partially overlap each other in a moving direction along a length direction of the tape winding target, while the tape set is moved by an amount of movement per the lapped winding that is a sum of the tape spacing and a lapping width, and a winding end step in which, subsequent to the lapped winding step, tape winding is performed on a winding end location of the tape winding target by a same winding manner as that of the winding start step.

In order to solve the above problems, a wire harness includes a tape winding target including a single electric wire or a bundle of a plurality of electric wires, a winding start portion where tape winding is performed on a winding start location of the tape winding target by a predetermined winding manner, a lapped winding portion where, subsequent to the winding start portion, lapped winding in which adjacent tapes of a plurality of tapes partially overlap each other in a length direction of the tape winding target is performed, wherein a winding length of each of the tapes in the length direction per winding of the lapped winding is a sum of the tape spacing and a lapping width, and a winding end portion where, subsequent to the lapped winding portion, tape winding is performed on a winding end location of the tape winding target by a same winding manner as that of the winding start step, wherein the tape winding is performed by the above-described tape winding method.

### Advantageous Effects of Invention

According to the tape winding method and the wire harness, the efficiency of the tape winding task can be improved while securing a desired lapping width.

### BRIEF DESCRIPTION OF THE DRAWINGS

FIG. 1 is a schematic diagram illustrating a wire harness according to an embodiment, along with a tape set used in a tape winding task for the wire harness.

FIG. 2 is a schematic diagram illustrating an initial stage of processing in a tape winding method for forming the wire harness illustrated in FIG. 1.

FIG. 3 is a schematic diagram illustrating processing subsequent to the initial stage of FIG. 2 in the tape winding method for forming the wire harness illustrated in FIG. 1.

FIG. 4 is a diagram illustrating a further abstraction of the tape winding method illustrated in FIGS. 2 and 3.

FIG. 5 is a schematic diagram illustrating a modified example of the embodiment illustrated in FIGS. 1 to 4.

### DETAILED DESCRIPTION OF THE EXEMPLARY EMBODIMENT

An embodiment of the tape winding method and the wire harness is described below.

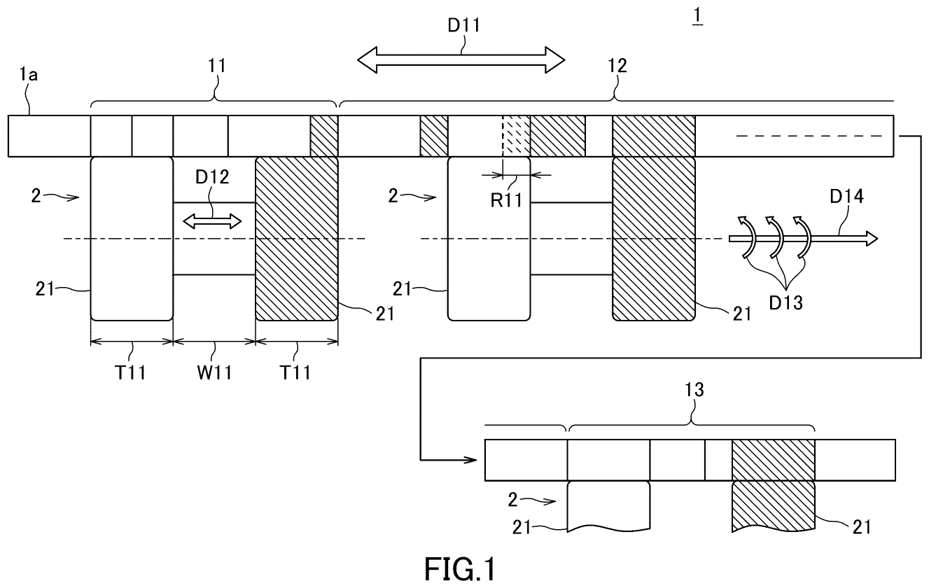

FIG. 1 is a schematic diagram illustrating a wire harness according to an embodiment along with a tape set used in a tape winding task for the wire harness.

The wire harness 1 according to the present embodiment is, for example, mounted and routed in a vehicle or the like. The wire harness 1 is configured with tapes wound around its outer periphery for the purpose of waterproofing and the like. The wire harness 1 includes a tape winding target 1a, a winding start portion 11, a lapped winding portion 12, and a winding end portion 13.

The tape winding target la is an electric wire portion having one electric wire or a bundle of multiple electric wires. The winding start portion 11 is a portion where a tape is wound around the winding start location of the tape winding target la using a winding manner described below. The lapped winding portion 12 is a tape wound portion that follows the winding start portion 11. This lapped winding portion 12 is a portion where the following lapped winding is performed continuously in the length direction D11 of the tape winding target 1a. The lapped winding in this lapped winding portion 12 is a winding manner in which adjacent tapes 21 out of multiple (two in the present embodiment) tapes 21 having the same tape width T11 overlap each other at a desired lapping width R11 (⅓ of the tape width T11 in the present embodiment). The winding end portion 13 is a portion where, subsequent to the lapped winding portion 12, a tape is wound around the winding end location of the tape winding target la using the same winding manner as that used for the winding start portion 11.

A tape set 2 including two tapes 21 of the same tape width T11 arranged in the winding axis direction D12 with a tape spacing W11 equal to the tape width T11 is used for tape winding of any of the winding start portion 11, the lapped winding portion 12, and the winding end portion 13. This tape winding is performed by moving the tape set 2 in a moving direction D14 along the length direction D11 of the tape winding target la while rotating the tape set 2 around the tape winding target 1a in a rotation direction D13.

A tape winding method for forming such a wire harness 1 is described below.

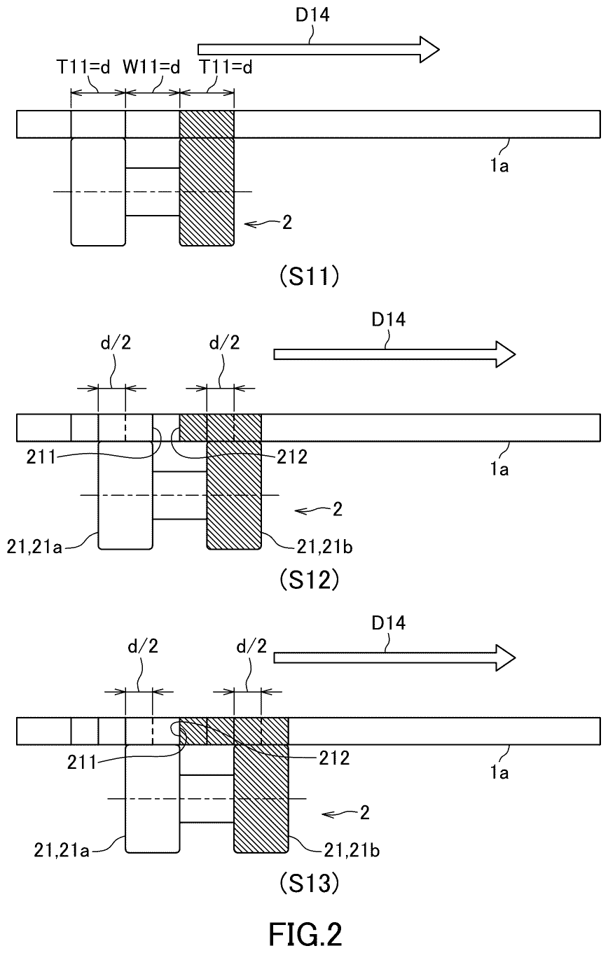

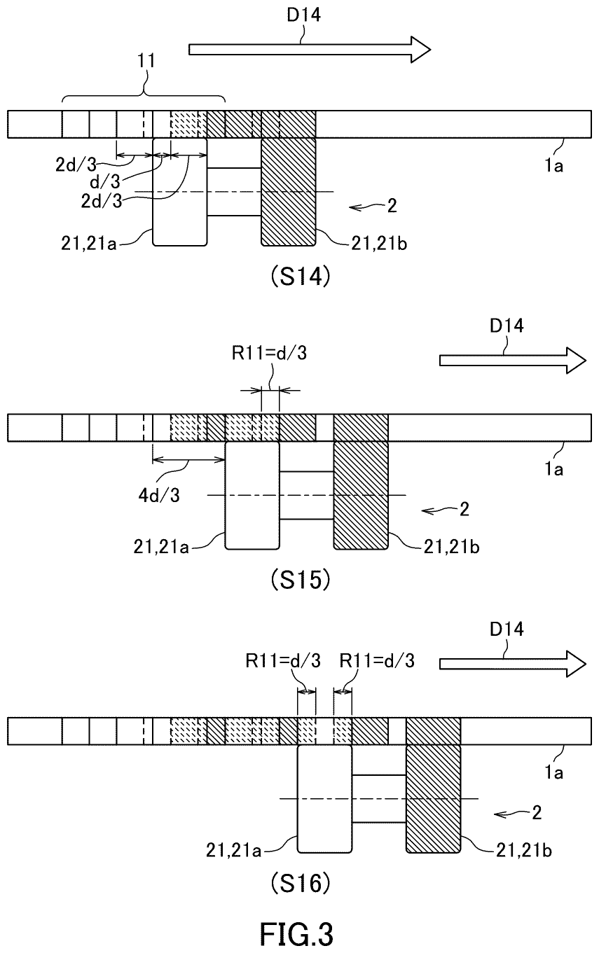

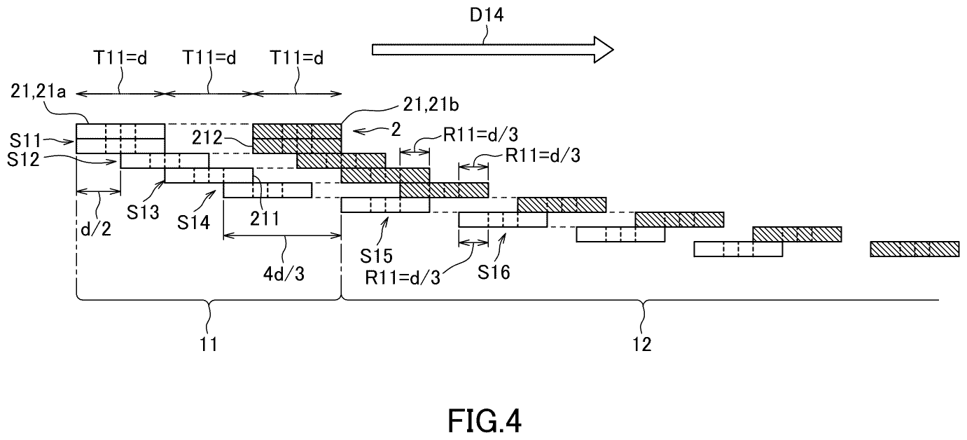

FIG. 2 is a schematic diagram illustrating an initial stage of processing in the tape winding method for forming the wire harness illustrated in FIG. 1. FIG. 3 is a schematic diagram illustrating processing subsequent to the initial stage of FIG. 2 in the tape winding method for forming the wire harness illustrated in FIG. 1. FIG. 4 is a diagram illustrating a further abstraction of the tape winding method illustrated in FIGS. 2 and 3.

In step S11 of the tape winding method illustrated in these FIGS. 2 to 4, non-moving tape winding is performed two or more times (twice in the present embodiment) around the tape winding target la without moving the tape set 2 in the moving direction D14. As a result of the non-moving tape winding in step S11, the two tapes 21 are wound twice with the tape spacing W11 between them. In the present embodiment, the tape spacing W11 is the same as the tape width T11, and this distance is referred to as a reference distance d in the following explanation.

In subsequent steps S12 and S13, a first lapping step is performed as follows. This first lapping step is a step for performing a first lapped winding in which each of the two tapes 21 of the tape set 2 partially overlaps the tape 21 itself. In the present embodiment, each of the tapes 21 overlaps the tape 21 itself by ⅓ of the width or more (specifically, ½ of the width, as described below). This first lapped winding is performed until a front side edge 211 of a rear tape 21a of the two tapes 21 coincides with a rear side edge 212 of a front tape 21b. The rear tape 21a is a tape 21 that is wound at the rearmost side in the moving direction D14, and the front tape 21b is a tape 21 that is wound adjacent to the rear tape 21 at the front side in the moving direction D14. The front side edge 211 is the front side edge of the tape 21 wound around the tape winding target 1a in the moving direction D14, and the rear side edge 212 is the rear side edge of the wound tape 21 in the moving direction D14.

In the present embodiment, the tape spacing W11 is a reference distance d, which is equal to the tape width T11. The first lapping step is a step for performing the half-lapped winding as the first lapped winding twice, in which each of the two tapes 21 partially overlaps the tape 21 itself by ½ of the width, i.e., half the reference distance d, until the following lapping state is attained. That is, the half-lapped winding, serving as the first lapped winding, is performed twice until the front side edge 211 of the rear tape 21a coincides with the rear side edge 212 of the front tape 21b. In steps S12 and S13, the tape set 2 is moved by ½ of the width in moving direction D14.

In step S14 following the first lapping step described above, the second lapping step as described below is performed. The second lapping step is a step for performing a second lapped winding once, in which, while the tape set 2 is moved in the moving direction D14, each of the two tapes 21 partially overlaps the tape 21 itself and the rear tape 21a partially overlaps the front tape 21b. In the present embodiment, the second lapped winding is a tape winding in which each of the tapes 21 overlaps the tape 21 itself by ⅓ of the width or more, specifically, ⅓ of the width, i.e., by ⅓ of the reference distance d, and the rear tape 21a overlaps the front tape 21b by ⅓ of the width or more, specifically, ⅓ of the width. As a result of this second lapping step in step S14, the boundary between the rear tape 21a and the front tape 21b formed in the stage of step S13 is covered with the rear tape 21a wound thereon. In the second lapping step in step S14, the tape set 2 is moved in the moving direction D14 by ⅔ of the width, i.e., by ⅔ of the reference distance d.

The processing in step S11 to step S14 described above is a winding start step for forming the winding start portion 11 illustrated in FIG. 1 by performing tape winding on the winding start location of the tape winding target 1b.

In the next step S15, the lapped winding is performed once, in which the two tapes 21 adjacent to each other in the tape set 2 partially overlap in the moving direction D14. In the present embodiment, the lapped winding in this case is a tape winding in which the rear tape 21a overlaps the front tape 21b by ⅓ of the width or more, specifically ⅓ of the width, i.e., by ⅓ of the reference distance d. At this time, the rear tape 21a is separated by ⅓ of the width from the previously wound rear tape 21a located at the rear in the moving direction D14, but the previously wound front tape 21b is present in this separated portion. The presence of this previously wound front tape 21b secures lapping of the separated portion of the rear tape 21a. In this step S15, the tape set 2 is moved in the moving direction D14 by the amount of movement per lapped winding, i.e., the sum of the tape spacing W11, which is equal to the reference distance d, and the lapping width R11, which is ⅓ of the reference distance d. That is, the amount of movement is 4/3 of the reference distance d. This amount of movement is a winding length in the length direction D11 per winding of the lapped winding of each of the tapes 21.

In the next step S16, the lapped winding is performed in a manner similar to step S15. In this lapped winding in step S16, the front side of the rear tape 21a overlaps the front tape 21b by ⅓ of the width, and the rear side overlaps the previously wound front tape 21b by ⅓ of the width. In this way, on both the front and rear sides of the front tape 21b, the lapping width R11 on the front tape 21b by ⅓ of the width is secured. Hereafter, the lapped winding similar to step S16 continues continuously to the winding end location of the tape winding target 1a, while the tape set 2 is moved by the amount of movement ( 4/3 of the reference distance d) described above per lapped winding. The lapped winding by the amount of movement from step S15 onwards is a lapped winding step for performing lapped winding in which adjacent tapes 21 overlap each other by ⅓ of the width or more, while moving the tape set 2 by the above amount of movement per lapped winding. As a result of this lapped winding step, the lapped winding portion 12 illustrated in FIG. 1 is formed.

When the tape set 2 reaches the winding end location, the lapped winding step ends, and the winding end step is performed, in which the tapes are wound using the same winding manner as in the winding start step of steps S11 to S14. However, in this winding end step, first, a first lapping step for performing half-lapped winding twice in steps S12 and S13, and a second lapping step in step S14, are performed. After the second lapping step, non-moving tape winding is performed twice in step S11. This winding end step forms the winding end portion 13 illustrated in FIG. 1, completing the tape winding method for performing tape winding on the wire harness 1.

According to the tape winding method of the embodiment described above, in areas where lapped winding is required, lapped winding in which adjacent tapes 21 overlap partially (in the present embodiment, by ⅓ of the width or more) is performed by moving tape set 2 as follows. Specifically, the lapped winding is performed while moving the tape set 2 by the sum of the tape spacing W11 and the lapping width R11 (the amount of movement per lapped winding). While such movement secures the desired lapping width R11, such movement improves the efficiency of the tape winding task, as compared with lapped winding in which the amount of movement of the tapes per winding is limited to the lapping width R11.

For example, when a tape winding task is performed with half-lapped winding using a single tape having a width of 19 mm, the amount of movement of the tapes per winding is 9.5 mm. Even if the lapping width R11 is set to ⅓ of the width, the amount of movement of the tapes per winding can only reach 12.6 mm at maximum because it is limited by the lapping width R11.

In contrast, according to the tape winding method of the present embodiment, the amount of movement per lapped winding ( 4/3 of the reference distance d, which is equal to the tape width T11) is 25.3 mm for the tape 21 having the width of 19 mm, which can improve the efficiency of the task to 183%. For a tape 21 having a width of 25 mm, the amount of movement becomes 33.3 mm, which can improve the efficiency of the task to 244%.

In the present embodiment, both of the winding start step and the winding end step are steps including the first lapping step in step S12 and step S13 and the second lapping step in step S14. The first lapping step is a step for performing the first lapped winding in which each of the tapes 21 partially overlaps (in the present embodiment, by ⅓ of the width or more) the tape 21 itself until the front side edge 211 of the rear tape 21a coincides with the rear side edge 212 of the front tape 21b. The second lapping step is a step for performing the second lapped winding once, in which each of the tapes 21 partially overlaps (in the present embodiment, by ⅓ of the width or more) the tape 21 itself, and the rear tape 21a overlaps the front tape 21b (in the present embodiment, by ⅓ of the width or more). According to this configuration, the lapping width R11 of ⅓ of the width or more can be secured not only in the lapped winding step, but also in the winding start step, the transition from the winding start step to the lapped winding step, the transition from the lapped winding step to the winding end step, and the winding end step.

Furthermore, in the present embodiment, the two tapes 21 have the same the tape width T11, the tape spacing W11 is the reference distance d which is the same as the tape width T11, and the first lapping step is a step for performing the half-lapped winding twice. According to this configuration, the first lapping step in which the amount of movement of the tape set 2 is limited to ½ of the width of the tape, the number of times the half-lapped winding is performed is limited to twice, which is the minimum required number, which further improves the efficiency of the tape winding task, including the winding start step and winding end step.

Furthermore, in the present embodiment, the winding start step is a step for performing non-moving tape winding twice or more prior to the first lapping step, and the winding end step is a step for performing non-moving tape winding twice or more subsequent to the second lapping step. According to this configuration, the non-moving tape winding is performed in both the initial step of the winding start step and the final step of the winding end step, which can stabilize the winding state at the winding start and winding end.

Furthermore, the wire harness 1 according to the present embodiment is formed by performing tape winding on the tape winding target la by the tape winding method explained above. Specifically, the above-described tape winding method is adopted in the manufacturing of this wire harness 1, which improves the efficiency of the tape winding task while maintaining the desired lapping width R11 of ⅓ of the width or more.

Next, a modified example of the above-described embodiment is described.

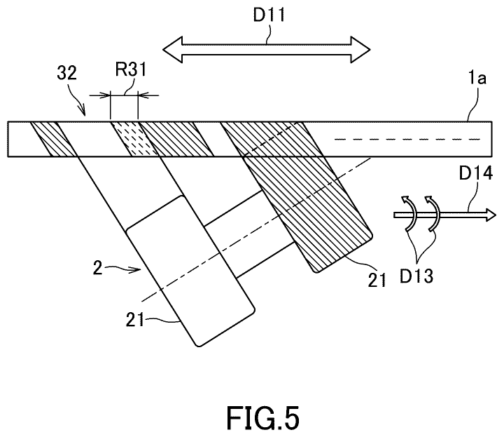

FIG. 5 is a schematic diagram illustrating a modified example of the embodiment illustrated in FIGS. 1 to 4.

The modified example illustrated in FIG. 5 differs from the above-described embodiment in the way tapes 21 are wound around a lapped winding portion 32 of a wire harness 3 and in the orientation of a tape set 2 relative to a tape winding target la during the lapped winding step that forms the lapped winding portion 32. The following describes this modified example, focusing on the differences from the above-described embodiment. FIG. 5 illustrates only a portion of the lapped winding portion 32 of the wire harness 3 according to the modified example that corresponds to the contents related to the lapped winding portion 12 illustrated in FIG. 1, along with the tape set 2. In FIG. 5, constituent elements equivalent to those in the embodiment illustrated in FIG. 1 are denoted with the same reference numerals as in FIG. 1 only where necessary for the explanation. In the following, a duplicate explanation of these equivalent elements is omitted.

In the above-described embodiment, during lapped winding, the tape set 2 is arranged such that each of the tapes 21 is oriented substantially perpendicular to the length direction D11 of the tape winding target 1a. In contrast, in the present modified example, lapped winding is performed by tilting the tape set 2 so that the tapes 21 of the tape set 2 are obliquely wound at a predetermined angle to the length direction D11 of the tape winding target 1a. The lapped winding is performed by rotating the tape set 2 thus tilted around the tape winding target la in the rotation direction D13 and moving the tape set 2 in the moving direction D14 along the length direction D11 of the tape winding target 1a. The lapped winding portion 32 formed by this type of lapped winding is formed such that adjacent tapes 21, each of which is obliquely wound at the predetermined angle, partially overlap each other. At this time, the lapping width R31 along the length direction D11 of the lapping portion that is tilted according to the tilt of the tape 21 is ⅓ of the width of the tape width T11.

In the present modified example, the lapped winding portion 32 is formed by the lapped winding step using the oblique winding described above. Although not explained further, the winding start step and the winding end step, before and after the lapped winding step. are performed with the tape set 2 positioned such that the tapes 21 are substantially perpendicular to the length direction D11, as in the above-described embodiment. However, the above-described oblique winding may be partially used for the winding start step and the winding end step as well. That is, the lapped winding after the non-moving tape winding in the winding start step, and the lapped winding before the non-moving tape winding in the winding end step may also be performed using the above-described oblique winding.

According to the modified example described above, it should be understood that, like the above-described embodiment, the efficiency of the tape winding task can be improved while ensuring the desired lapping width R31 (in this modified embodiment, ⅓ of the width or more, specifically ⅓ of the width).

Furthermore, in the present modified example, of the winding start step, the lapped winding step, and the winding end step, at least the lapped winding step (in this modified embodiment, only the lapped winding step) is performed by obliquely winding the tape set 2 at an angle. According to this configuration, the tapes 21 of the tape set 2 are wound obliquely, so that the tape winding range per one winding is wider than when the tapes 21 are wound substantially perpendicular to the length direction D11. This increased tape winding range per one tape winding can further improve the efficiency of the tape winding task.

The embodiment and modified example described above are merely representative forms of the tape winding method and the wire harness. The tape winding method and the wire harness are not limited thereto, and can be implemented in various modifications.

For example, in the above-described embodiment and modified example, the wire harness 1 that is mounted on and routed in a vehicle or the like is presented as an example of the wire harness. However, the wire harness is not limited thereto, and its specific application is not particularly limited.

Furthermore, in the above-described embodiment and modified example, the tape set 2 including two tapes 21 arranged in the winding axis direction D12 is presented as an example of a tape set used for the tape winding method. However, the tape set is not limited thereto, and any number of tapes may be used as long as it is more than one.

Furthermore, in the above-described embodiment and modified example, the following step is presented as an example of the lapped winding step. That is, the lapped winding steps S15 and S16 in which the adjacent tapes 21 overlap each other by ⅓ of the width or more, specifically ⅓ of the width (⅓ of the reference distance d) are presented. However, the lapping width in the lapped winding step may be any other lapping width as long as it is a lapping width which allows for partial overlapping.

Furthermore, in the above-described embodiment and modified example, a step including the first lapping step in step S12 and step S13 and the second lapping step in step S14 is presented as an example of each of the winding start step and the winding end step. However, the winding start step and the winding end step are not limited thereto, and its specific winding method is not particularly limited. However, as described above, when the first lapping step and the second lapping step of step S14 explained above are performed, the desired lapping widths R11, R31 (in this case, ⅓ of the width or more) for each step from the winding start step to the winding end step can be ensured.

Furthermore, in the above-described embodiment and modified example, the following step is presented as an example of the first lapping step. That is, the above-described embodiment and modified example presented the first lapping steps in steps S12 and S13, in which half-lapped winding is performed twice, with the two tapes 21 of the tape set 2 having the same tape width T11 as each other, and the tape spacing W11 being equal to the tape width T11. However, the first lapping step is not limited thereto, and the tape widths of multiple tapes in a tape set may be different from each other, and the tape spacing of the tape set, the lapping width corresponding to the tape spacing, and the number of tape windings may be set to any value. However, as described above, when the tape spacing W11 of two tapes 21 having the same width is set equal to the tape width T11 and the half-lapped winding is configured to be performed twice, the efficiency of the tape winding task can be further improved, including the winding start step and winding end step.

Furthermore, in the above-described embodiment and modified example, the step in which the non-moving tape winding is performed two or more times is presented as an example of each of the winding start step and the winding end step. However, the winding start step and the winding end step are not limited thereto, and may be a step in which the non-moving tape winding is not particularly performed. However, as mentioned above, when the non-moving tape winding is performed two or more times, the winding condition at the winding start and winding end can be stabilized. In the present embodiment, a step in which the non-moving tape winding is performed twice in the winding start step and the winding end step is exemplified, but the number of times the non-moving tape winding is performed is not limited to two, and the specific number of times is not particularly limited as long as it is two or more.

Furthermore, in the above-described modified example, the tape winding method in which, among the winding start step, the lapped winding step, and the winding end step, the lapped winding step is performed by oblique winding, is presented as an example of the tape winding method. However, the tape winding method is not limited thereto, and may instead be such that, as in the above-described embodiment, in every step, the tape winding is performed with the tape set 2 being arranged such that each of the tapes 21 is oriented substantially perpendicular to the length direction D11 of the tape winding target 1a. Furthermore, even when the oblique winding is used, as described above, the steps to which the oblique winding is applied are not limited to the lapped winding steps, and the oblique winding may be used for the winding start step or the winding end step.

### List of Reference Signs

1,3 wire harness
1a tape winding target
2 tape set
11 winding start portion
12, 32 lapped winding portion
13 winding end portion
21 tape
21a rear tape
21b front tape
211 front side edge
212 rear side edge
d reference distance
D11 length direction
D12 winding axis direction
D13 rotation direction
D14 moving direction
R11, R31 lapping width
T11 tape width
W11 tape spacing

What is claimed is:

1. A tape winding method comprising:
a winding start step in which a single electric wire or a bundle of a plurality of electric wires is adopted as a tape winding target, and tape winding is performed on a winding start location of the tape winding target by a predetermined winding manner;
a lapped winding step in which, subsequent to the winding start step, a tape set including a plurality of tapes arranged in a winding axis direction with a predetermined tape spacing is used to perform lapped winding in which adjacent tapes of the plurality of tapes partially overlap each other in a moving direction along a length direction of the tape winding target, while the tape set is moved by an amount of movement per the lapped winding that is a sum of the tape spacing and a lapping width; and
a winding end step in which, subsequent to the lapped winding step, tape winding is performed on a winding end location of the tape winding target by a same winding manner as that of the winding start step.

2. The tape winding method according to claim 1, wherein both of the winding start step and the winding end step are steps including:
a first lapping step of performing a first lapped winding, in which each of the plurality of tapes partially overlaps the tape itself, until a front side edge in the moving direction of a rear tape of the plurality of tapes, which is wound around a rearmost side in the moving direction, coincides with or exceeds a rear side edge in the moving direction of a front tape which is wound adjacent to a front side of the rear tape in the moving direction; and
a second lapping step of performing, subsequent to the first lapping step, a second lapped winding once, in which, while the tape set is moved in the moving direction, each of the plurality of tapes partially overlaps the tape itself and the rear tape partially overlaps the front tape.

3. The tape winding method according to claim 2, wherein the plurality of tapes have a same tape width as each other,
the tape spacing is a same spacing as the tape width, and
the first lapping step is a step of performing, as the first lapped winding, half-lapped winding twice in which each of the plurality of tapes overlaps the tape itself by ½ of the tape width, until the front side edge of the rear tape coincides with the rear side edge of the front tape.

4. The tape winding method according to claim 2, wherein the winding start step is a step of performing, prior to the first lapping step, non-moving tape winding for two or more times, in which tape winding is performed without moving the tape set in the moving direction, and
the winding end step is a step of performing, subsequent to the second lapping step, the non-moving tape winding for two or more times.

5. The tape winding method according to claim 1, wherein of the winding start step, the lapped winding step, and the winding end step, at least the lapped winding step is a step of performing the lapped winding by tilting the tape set so that the tapes of the tape set are obliquely wound at a predetermined angle to the length direction of the tape winding target.

6. A wire harness comprising:
a tape winding target including a single electric wire or a bundle of a plurality of electric wires;
a winding start portion where tape winding is performed on a winding start location of the tape winding target by a predetermined winding manner;
a lapped winding portion where, subsequent to the winding start portion, lapped winding is performed, in which adjacent tapes of a plurality of tapes partially overlap each other in a length direction of the tape winding target, where a winding length in the length direction per winding of the lapped winding of each of the tapes is a sum of the tape spacing and a lapping width; and
a winding end portion where, subsequent to the lapped winding portion, tape winding is performed on a winding end location of the tape winding target by a same winding manner as that of the winding start step,
wherein the tape winding is performed by the tape winding method according to claim 1.

7. A wire harness comprising:
a tape winding target including a single electric wire or a bundle of a plurality of electric wires;
a winding start portion where tape winding is performed on a winding start location of the tape winding target by a predetermined winding manner;
a lapped winding portion where, subsequent to the winding start portion, lapped winding is performed, in which adjacent tapes of a plurality of tapes partially overlap each other in a length direction of the tape winding target, where a winding length in the length direction per winding of the lapped winding of each of the tapes is a sum of the tape spacing and a lapping width; and
a winding end portion where, subsequent to the lapped winding portion, tape winding is performed on a winding end location of the tape winding target by a same winding manner as that of the winding start step,
wherein the tape winding is performed by the tape winding method according to claim 2.

8. A wire harness comprising:
a tape winding target including a single electric wire or a bundle of a plurality of electric wires;
a winding start portion where tape winding is performed on a winding start location of the tape winding target by a predetermined winding manner;
a lapped winding portion where, subsequent to the winding start portion, lapped winding is performed, in which adjacent tapes of a plurality of tapes partially overlap each other in a length direction of the tape winding target, where a winding length in the length direction per winding of the lapped winding of each of the tapes is a sum of the tape spacing and a lapping width; and
a winding end portion where, subsequent to the lapped winding portion, tape winding is performed on a winding end location of the tape winding target by a same winding manner as that of the winding start step,
wherein the tape winding is performed by the tape winding method according to claim 3.

9. A wire harness comprising:
a tape winding target including a single electric wire or a bundle of a plurality of electric wires;
a winding start portion where tape winding is performed on a winding start location of the tape winding target by a predetermined winding manner;
a lapped winding portion where, subsequent to the winding start portion, lapped winding is performed, in which adjacent tapes of a plurality of tapes partially overlap each other in a length direction of the tape winding target, where a winding length in the length direction per winding of the lapped winding of each of the tapes is a sum of the tape spacing and a lapping width; and
a winding end portion where, subsequent to the lapped winding portion, tape winding is performed on a winding end location of the tape winding target by a same winding manner as that of the winding start step,
wherein the tape winding is performed by the tape winding method according to claim 4.

10. A wire harness comprising:
a tape winding target including a single electric wire or a bundle of a plurality of electric wires;
a winding start portion where tape winding is performed on a winding start location of the tape winding target by a predetermined winding manner;
a lapped winding portion where, subsequent to the winding start portion, lapped winding is performed, in which adjacent tapes of a plurality of tapes partially overlap each other in a length direction of the tape winding target, where a winding length in the length direction per winding of the lapped winding of each of the tapes is a sum of the tape spacing and a lapping width; and
a winding end portion where, subsequent to the lapped winding portion, tape winding is performed on a winding end location of the tape winding target by a same winding manner as that of the winding start step,
wherein the tape winding is performed by the tape winding method according to claim
